(19) United States
(12) Patent Application Publication
(10) Pub. No.: US 2023/0254555 A1
(43) Pub. Date: Aug. 10, 2023

(54) ELECTRONIC APPARATUS, CONTROL METHOD THEREFOR, AND COMPUTER-READABLE STORAGE MEDIUM STORING PROGRAM

(71) Applicant: CANON KABUSHIKI KAISHA, Tokyo (JP)

(72) Inventor: TOSHIAKI UEGURI, Tokyo (JP)

(21) Appl. No.: 18/164,338

(22) Filed: Feb. 3, 2023

(30) Foreign Application Priority Data
Feb. 7, 2022 (JP) 2022-017379

(51) Int. Cl. H04N 23/45; H04N 23/90

(52) U.S. Cl. CPC H04N 23/45; H04N 23/90

(57) ABSTRACT

An electronic apparatus includes a plurality of image capturing units, a first display device, a connection unit that connects an external second display device to the electronic apparatus, and a control unit that controls, depending on a number of display devices including the first display device and the external second display device, displaying a plurality of images generated by the plurality of image capturing units on the display devices in a different mode.

### BACKGROUND

### Field

The present disclosure relates to an electronic apparatus, a control method for the electronic apparatus, and a computer-readable storage medium storing a program.

### Description of the Related Art

Conventionally, there is known an electronic apparatus that includes a plurality of image capturing units and can simultaneously capture images using the plurality of image capturing units. In addition, there is known an apparatus that combines and displays images captured by a plurality of image capturing units on a single display device.

Japanese Patent Application Laid-Open No. 2013-110764 discusses an eyeglass type imaging display apparatus that simultaneously displays an image based on a display image signal generated by a first image signal generation unit, which represents a scene in a direction of a user's field of view, and another image based on a display image signal generated by a second image signal generation unit.

Japanese Patent Application Laid-Open No. 2020-162139 discusses an image capturing apparatus that can set a plurality of image capturing modes and combine and display images simultaneously captured by a plurality of image capturing units on a display device.

The apparatuses discussed in Japanese Patent Application Laid-Open No. 2013-110764 and No. 2020-162139 have an issue that a user cannot easily view the images captured by a plurality of image capturing units because the display of the plurality of images on a single display device causes the images to be partially hidden or to be displayed small.

### SUMMARY

According to an aspect of the present disclosure, an electronic apparatus includes a plurality of image capturing units, a first display device, a connection unit configured to connect an external second display device to the electronic apparatus, and a control unit configured to control, depending on a number of display devices including the first display device and the external second display device, displaying a plurality of images generated by the plurality of image capturing units on the display devices in a different mode.

Further features will become apparent from the following description of exemplary embodiments with reference to the attached drawings.

### BRIEF DESCRIPTION OF THE DRAWINGS

FIGS. 1A and 1B are views illustrating an external appearance of a smartphone.

FIG. 2 is a block diagram illustrating a configuration of the smartphone.

FIGS. 3A and 3B are views illustrating an external appearance of another smartphone.

FIG. 4 is a block diagram illustrating a configuration of the other smartphone.

FIG. 5A illustrates an example of an image displayed on a display of the smartphone. FIG. 5B illustrates an example of an image displayed on the display of the smartphone. FIG. 5C illustrates an example of an image displayed on the display of the smartphone and an example of an image displayed on a display of the other smartphone. FIG. 5D illustrates an example of an image displayed on the display of the smartphone and an example of an image displayed on the display of the other smartphone. FIG. 5E illustrates an example of an image displayed on the display of the smartphone and an example of an image displayed on the display of the other smartphone. FIG. 5F illustrates an example of an image displayed on the display of the smartphone and an example of an image displayed on the display of the other smartphone.

FIGS. 6A1 and 6A2 are a flowchart illustrating processing according to a first exemplary embodiment. FIG. 6B is a flowchart illustrating image output control processing. FIG. 6C is a flowchart illustrating display processing. FIGS. 6D1 and 6D2 are a flowchart illustrating processing according to a second exemplary embodiment.

FIGS. 7A to 7G are diagrams illustrating examples of setting screens for imaging display settings.

### DESCRIPTION OF THE EMBODIMENTS

Exemplary embodiments will be described in detail below with reference to the attached drawings.

In the following exemplary embodiments, a smartphone will be described as an example of an electronic apparatus.

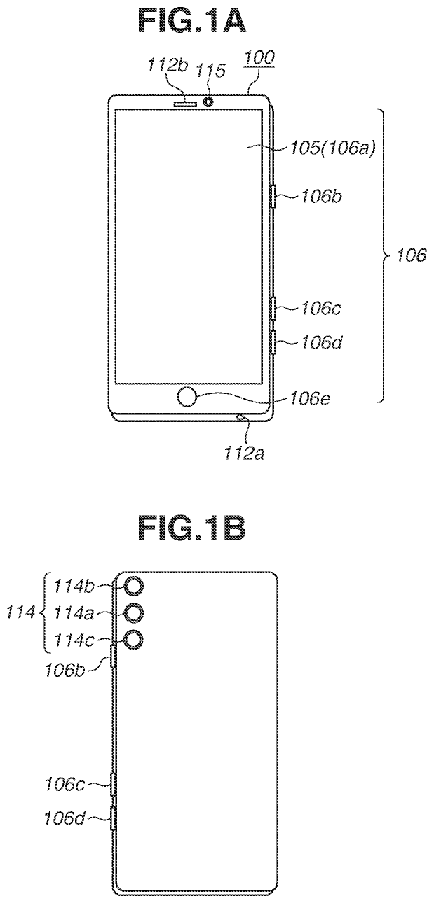

FIG. 1A is a front view of a smartphone 100 and FIG. 1B is a rear view of the smartphone 100.

The smartphone 100 includes a display 105, rear cameras 114 as image capturing units, and a front camera 115 as an image capturing unit.

The display 105 is a display device or a display unit that is provided on a front surface of the smartphone 100 and displays an image or various types of information. The smartphone 100 can display, on the display 105, a live view image (an LV image) captured by any of the rear cameras 114 and the front camera 115. The rear cameras 114 include a telephoto camera 114a, a standard camera 114b, and a super wide-angle camera 114c.

The smartphone 100 includes an operation unit 106. The operation unit 106 includes a touch panel 106a, a power button 106b, a volume plus button 106c, a volume minus button 106d, and a home button 106e.

The touch panel 106a is a touch operation member and can detect a touch operation performed on a display surface (an operation surface) of the display 105. The power button 106b is an operation member and can switch on and off a light of the display 105. When a user continuously presses (holds down) the power button 106b for a certain length of time, for example, three seconds, the power of the smartphone 100 can be switched on or off. The volume plus button 106c and the volume minus button 106d are used to control the volume of a sound output from an audio output unit 112 (described below). When the volume plus button 106c is pressed, the volume is increased, and when the volume minus button 106d is pressed, the volume is decreased. The volume plus button 106c or the volume minus button 106d also functions as a shutter button for issuing an image capturing instruction when pressed in an imaging standby state while any of the rear cameras 114 and the front camera 115 is in use. The user can optionally set a specific function so that the function can be performed when the user simultaneously presses the power button 106b and the volume minus button 106d, or quickly presses the volume minus button 106d several times.

The home button 106e is an operation button for displaying a home screen, which is a start-up screen of the smartphone 100, on the display 105. In a case where various applications are started up and used on the smartphone 100, the user can temporarily close the various operating applications and display the home screen by pressing the home button 106e. The home button 106e is assumed to be a physical button that can be pressed, but can be a touchable button having a similar function and displayed on the display 105 instead of the physical button. The smartphone 100 also includes an audio output terminal 112a and a loudspeaker 112b.

The audio output terminal 112a is an earphone jack and outputs a sound to an earphone or an external loudspeaker. The loudspeaker 112b is a built-in loudspeaker that outputs a sound. In a case where the smartphone 100 outputs a sound in a state where a terminal for outputting a sound, such as an earphone cord, is not attached to the audio output terminal 112a, the sound is output from the loudspeaker 112b.

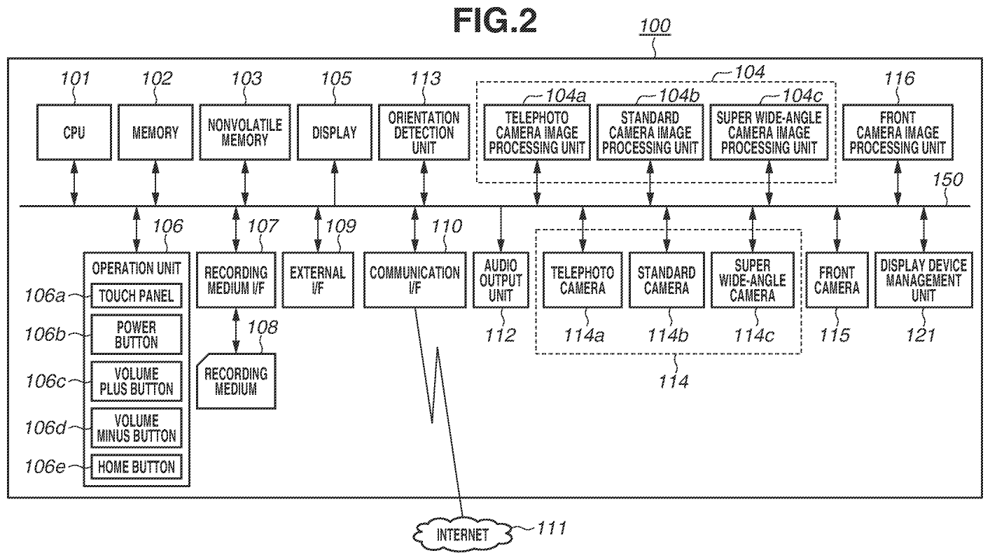

FIG. 2 is a block diagram illustrating an example of a configuration of the smartphone 100. In FIG. 2, the same components as those in FIGS. 1A and 1B are denoted by the same reference numerals.

In the smartphone 100, a central processing unit (CPU) 101, a memory 102, a nonvolatile memory 103, rear camera image processing units 104, the display 105, the operation unit 106, a recording medium interface (I/F) 107, an external I/F 109, and a communication I/F 110 are connected to an internal bus 150.

The audio output unit 112, an orientation detection unit 113, the rear cameras 114, the front camera 115, a front camera image processing unit 116, and a display device management unit 121 are also connected to the internal bus 150. The components connected to the internal bus 150 can exchange data with each other via the internal bus 150.

The CPU 101 is a control unit that controls the smartphone 100 and includes at least one processor or circuit. The memory 102 includes, for example, a random access memory (RAM) (e.g., a volatile memory using a semiconductor element). The CPU 101 controls the components of the smartphone 100 using the memory 102 as a work memory, for example, according to a program stored in the nonvolatile memory 103. The nonvolatile memory 103 stores data such as image data and audio data, and various programs for the CPU 101 to execute. The nonvolatile memory 103 includes, for example, a flash memory, and a read-only memory (ROM).

The rear camera image processing units 104 perform, based on control by the CPU 101, various types of image processing and subject recognition processing on images captured by the rear cameras 114. The rear camera image processing units 104 include a telephoto camera image processing unit 104a, a standard camera image processing unit 104b, and a super wide-angle camera image processing unit 104c for the telephoto camera 114a, the standard camera 114b, and the super wide-angle camera 114c, respectively. The rear camera image processing units 104 respectively perform processing on the images captured by the corresponding rear cameras 114. In the present exemplary embodiment, the three rear cameras 114 are provided with the respective rear camera image processing units 104, but all of the rear cameras 114 may not necessarily be provided with the respective individual rear camera image processing units 104. For example, any two of the rear cameras 114 can share one image processing unit, or all the three rear cameras 114 can share one image processing unit.

The front camera image processing unit 116 performs various types of image processing and subject recognition processing on an image captured by the front camera 115. Each of the rear camera image processing units 104 and the front camera image processing unit 116 can also perform various types of image processing on an image stored in the nonvolatile memory 103 or a recording medium 108, an image signal acquired via the external I/F 109, or an image acquired via the communication I/F 110. The image processing performed by each of the rear camera image processing units 104 and the front camera image processing unit 116 includes analog-to-digital (A/D) conversion processing, digital-to-analog (D/A) conversion processing, encoding processing, compression processing, decoding processing, enlargement/reduction processing (resizing), noise reduction processing, and color conversion processing on image data. Each of the rear camera image processing units 104 and the front camera image processing unit 116 can include a dedicated circuit block for performing specific image processing. The rear camera image processing units 104 can be integrated into one processing block, and perform parallel processing or time-division processing to collectively handle the images captured by the respective rear cameras 114. Depending on the type of image processing, the CPU 101 can perform image processing according to a program without using the rear camera image processing units 104 or the front camera image processing unit 116.

The display 105 displays an image, a graphical user interface (GUI) screen including a GUI, or the like, based on control by the CPU 101. The CPU 101 generates a display control signal based on a program and controls the components of the smartphone 100 to generate an image signal for displaying an image on the display 105 and output the image signal to the display 105. The display 105 displays the image based on the output image signal. In the present exemplary embodiment, the display 105 is integrated with the smartphone 100, but can be separated therefrom. In other words, the smartphone 100 can include an interface for outputting an image signal for displaying an image on the display 105, but not include the display 105 therein. In this case, the display 105 is an external monitor (e.g., a television).

The operation unit 106 is an input device that receives user operations. Examples of the input device include a character information input device such as a keyboard, a pointing device such as a mouse or a touch panel (e.g., the touch panel 106a), buttons, a dial, a joystick, a touch sensor, and a touch pad. The touch panel 106a is an input device that is superimposed in a flat manner on the display 105 and outputs coordinate information corresponding to a touched position. The operation unit 106 includes the touch panel 106a, the power button 106b, the volume plus button 106c, the volume minus button 106d, and the home button 106e described above.

The recording medium 108 such as a memory card can be attached to the recording medium I/F 107, and the recording medium I/F 107 reads and writes data from and to the attached recording medium 108 based on control by the CPU 101. The recording medium 108 can be an internal storage built into the smartphone 100. The external I/F 109 is an interface for connecting to an external device using a wired cable or wirelessly to input and output an image signal and an audio signal. The communication I/F 110 is an interface for communicating with an external device, an Internet 111, and the like, and transmitting and receiving various data such as files and commands.

The audio output unit 112 outputs a sound of a moving image or music data, an operation sound, a ringtone, various notification sounds, and the like. The audio output unit 112 includes the audio output terminal 112a for connecting an earphone and the loudspeaker 112b, but can output a sound via wireless communication.

The orientation detection unit 113 detects an orientation of the smartphone 100 with respect to a gravity direction and an inclination of the orientation with respect to each of yaw, roll, and pitch axes. Based on the orientation detected by the orientation detection unit 113, it is possible to determine whether the smartphone 100 is held horizontally or vertically, faces upward or downward, or is obliquely oriented. As the orientation detection unit 113, one or more of an acceleration sensor, a gyro sensor, a geomagnetic sensor, a direction sensor, and an altitude sensor can be used, or a plurality of these sensors can be used in combination.

The rear cameras 114 are arranged on an opposite side of the display 105 on a housing of the smartphone 100. The telephoto camera 114a has a longer focal length than that of the standard camera 114b and can capture an image on a more telephoto side than the standard camera 114b. The super wide-angle camera 114c has a shorter focal length than that of the standard camera 114b and can capture an image at a wider angle than the standard camera 114b. In other words, the super wide-angle camera 114c, the standard camera 114b, and the telephoto camera 114a have shorter focal lengths and wider angles of view in this order. In the present exemplary embodiment, the telephoto camera 114a is assumed to include a lens with a mechanism that optically zooms an image by a predetermined magnification, but can include a lens with a mechanism that enables the user to change the magnification. The front camera 115 is arranged on the same surface as the display 105 on the housing of the smartphone 100.

The three rear cameras 114, i.e., the telephoto camera 114a, the standard camera 114b, and the super wide-angle camera 114c can perform imaging operations at the same time. All of the three rear cameras 114 may not necessarily perform the operations at the same time. For example, any two of the three rear cameras 114 can perform the operations at the same time, or one of the rear cameras 114 can perform the operation independently. A live view image captured by any of the rear cameras 114 and the front camera 115 can be displayed on the display 105. By operating the touch panel 106a, the user can select a desired camera to display an image captured by the selected camera on the display 105. More specifically, if the telephoto camera 114a is selected, an image with a higher magnification than that of an image captured by the standard camera 114b can be displayed on the display 105. If the standard camera 114b is selected, an image with a wider angle than that of an image captured by the telephoto camera 114a and with a higher magnification than that of an image captured by the super wide-angle camera 114c can be displayed. If the super wide-angle camera 114c is selected, an image with a wider angle than those of images captured by the telephoto camera 114a and the standard camera 114b can be displayed. The user can also select whether to capture an image of a scene in front of the user or capture a selfie of the user by selecting which one of the rear cameras 114 and the front camera 115 to use.

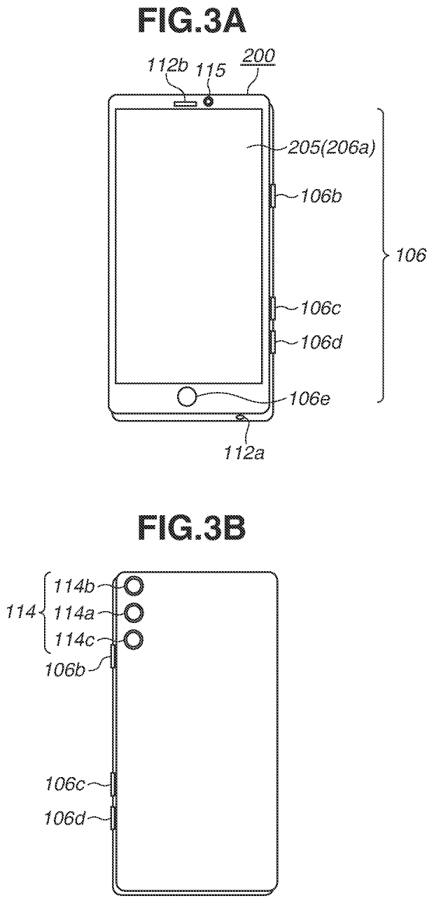

The display device management unit 121 manages the number of display devices in a case where the smartphone 100 is connected to another smartphone 200 (see FIG. 3A) via the external I/F 109, and also controls images to be displayed on the smartphone 100 and the smartphone 200. The image to be displayed on the smartphone 100 is displayed on the display 105, and the image to be displayed on the smartphone 200 is transmitted to the smartphone 200 via the external I/F 109.

As described above, the operation unit 106 includes the touch panel 106a. The CPU 101 can detect the following operations performed on the touch panel 106a and the following states.

newly touching the touch panel 106a with a user's finger or stylus that is not in contact with the touch panel 106a, i.e., start of a touch (hereinafter referred to as a “touch-down”)

state where the touch panel 106a is being touched with the user's finger or the stylus (hereinafter referred to as a “touch-on”)

movement of the user's finger or the stylus touching the touch panel 106a (hereinafter referred to as a “touch-move”)

separation of the user's finger or the stylus touching the touch panel 106a from the touch panel 106a, i.e., end of the touch (hereinafter referred to as a “touch-up”)

state where nothing touches the touch panel 106a (hereinafter referred to as a “touch-off”)

When the “touch-down” is detected, the “touch-on” is detected at the same time. Normally, after the “touch-down”, the “touch-on” continues to be detected unless the “touch-up” is detected. Also in a case where the “touch-move” is detected, the “touch-on” is detected at the same time. Even when the “touch-on” is detected, the “touch-move” is not detected unless the touched position moves. The “touch-off” is detected when the “touch-up” of all the user's fingers or the stylus touching the touch panel 106a is detected.

The CPU 101 is notified of information, such as the above-described operations and states, or position coordinates at which the user's finger or the stylus touches the touch panel 106a, via the internal bus 150. The CPU 101 determines, based on the information, what kind of operation (touch operation) is performed on the touch panel 106a. Regarding the “touch-move”, a moving direction of the user's finger or stylus moving on the touch panel 106a can also be determined for each of vertical and horizontal components on the touch panel 106a based on a change in the position coordinates. In a case where the “touch-move” with a predetermined distance or more is detected, a slide operation is determined to be performed.

An operation of quickly moving a user's finger touching the touch panel 106a by some distance and immediately releasing the user's finger therefrom is referred to as a “flick”. A “flick” is an operation of quickly moving a user's finger along the touch panel 106a as if flicking the touch panel 106a with the user's finger. The “flick” can be determined to be performed in a case where the “touch-move” performed at a predetermined speed or more for a predetermined distance or more is detected and the “touch-up” is subsequently detected. The “flick” can be determined to be performed following the slide operation. A touch operation in which a plurality of points (e.g., two points) is touched at the same time and the touched positions are brought closer to each other is referred to as a “pinch-in”, and a touch operation in which the touched positions are moved away from each other is referred to as a “pinch-out”. The “pinch-out” and the “pinch-in” are collectively referred to as a pinch operation (or simply referred to as a “pinch”).

The touch panel 106a can be any of various types of touch panels, such as a resistive film type, an electrostatic capacitance type, a surface acoustic wave type, an infrared type, an electromagnetic induction type, an image recognition type, and an optical sensor type. There are touch detection methods such as a method that detects a touch operation in a case where there is contact with the touch panel 106a and a method that detects a touch operation in a case where a user's finger or a stylus approaches the touch panel 106a, but any of the methods can be used.

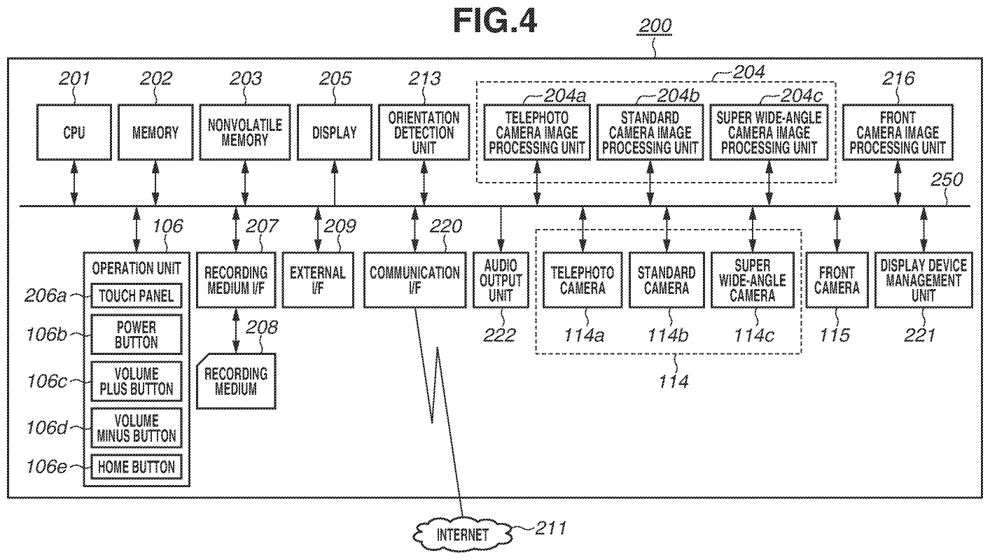

FIG. 3A is a front view of the smartphone 200 as another electronic apparatus, and FIG. 3B is a rear view of the smartphone 200. FIG. 4 is a block diagram illustrating an example of a configuration of the smartphone 200.

The smartphone 200 is similar in configuration to the smartphone 100, and a detailed description thereof will be omitted. The smartphone 200 is used as a display device by connecting to the smartphone 100, and thus the rear cameras 114 and the front camera 115 may not necessarily be provided therein.

A display 205 is a display device and can be larger or smaller than the display 105. An image to be displayed on the smartphone 200 is transmitted via the external I/F 109 of the smartphone 100 and received via an external I/F 209 of the smartphone 200 under the control of the display device management unit 121 of the smartphone 100.

In the present exemplary embodiment, processing for controlling a camera-captured image to be displayed in a different mode depending on the number of display devices connected to the smartphone 100 or the number of cameras being driven will be described.

In a first exemplary embodiment, the standard camera 114b and the telephoto camera 114a are simultaneously driven as a main camera and a sub camera, respectively, and in an initial state, one display device, i.e., the display 105 is connected to the smartphone 100. Processing for changing display states of the display 105 and the display 205 in a case where the smartphone 200 is connected to the smartphone 100 and the initial state changes to a state where two display devices, i.e., the display 105 and the display 205 are connected to the smartphone 100 will be described.

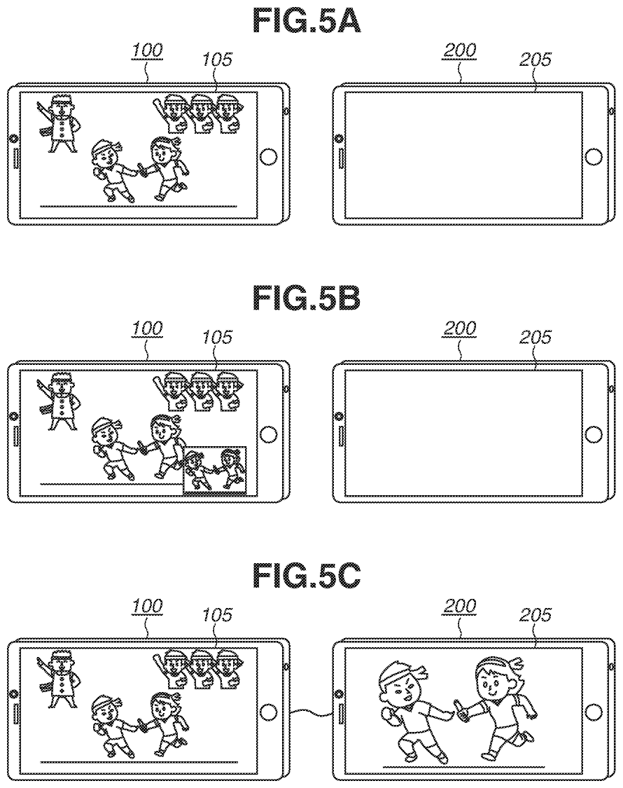

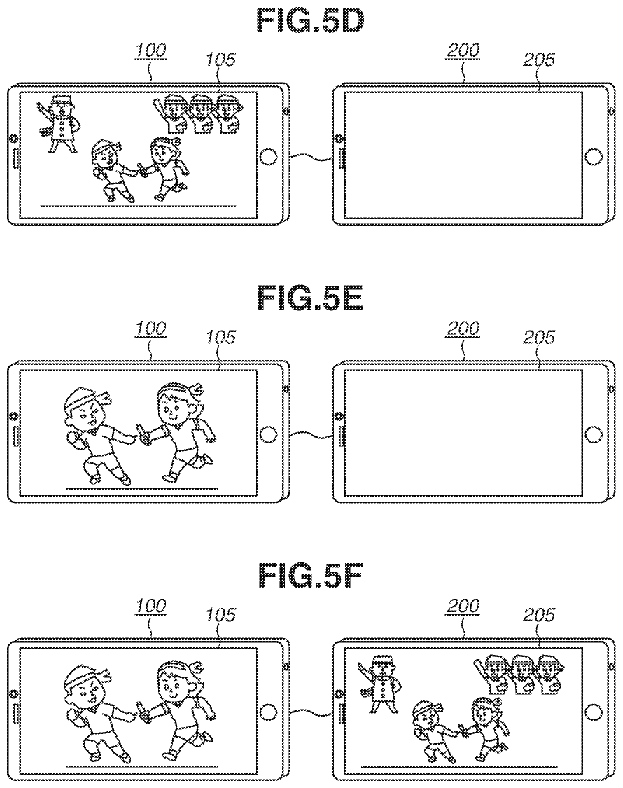

FIGS. 5A to 5D illustrate examples of images displayed on the display 105 of the smartphone 100 and the display 205 of the smartphone 200. FIGS. 5A and 5B each illustrate a state where the smartphone 100 is not connected to the smartphone 200. FIGS. 5C and 5D each illustrate a state where the smartphone 100 is connected to the smartphone 200.

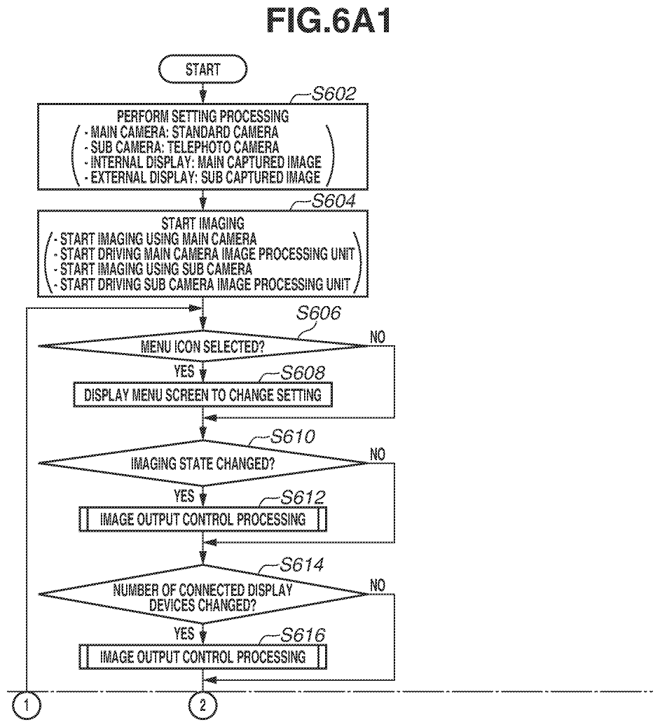

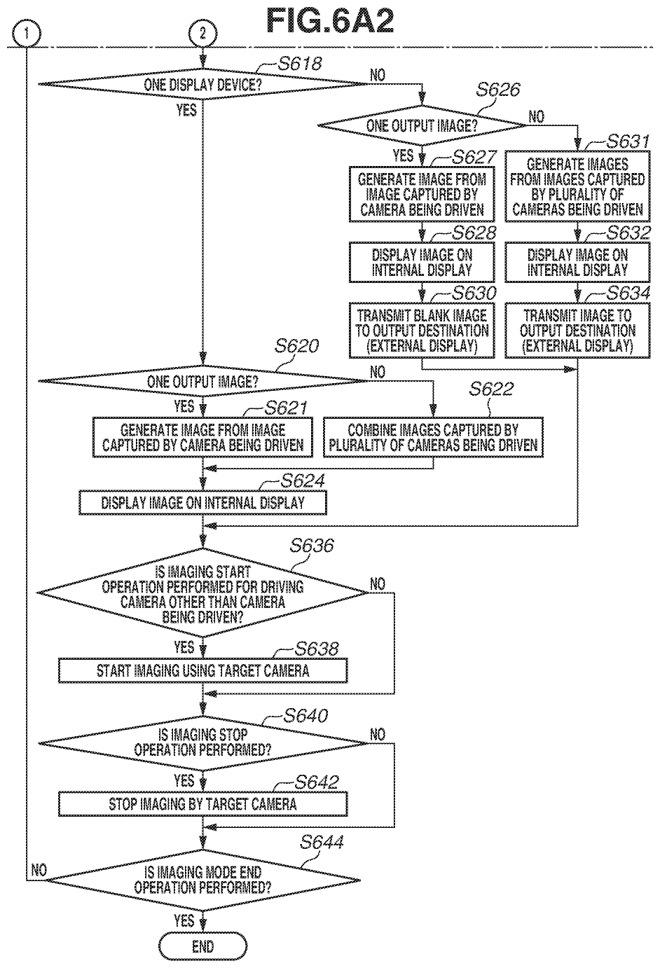

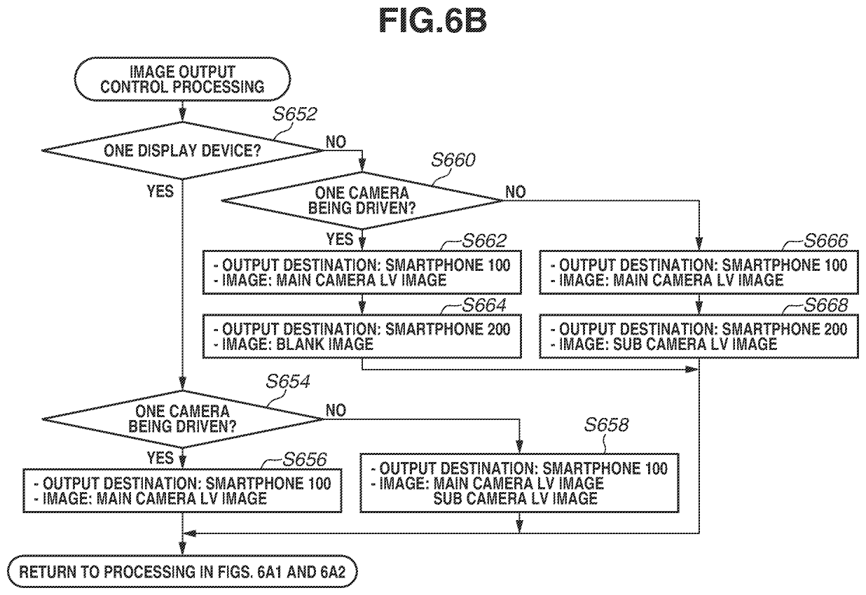

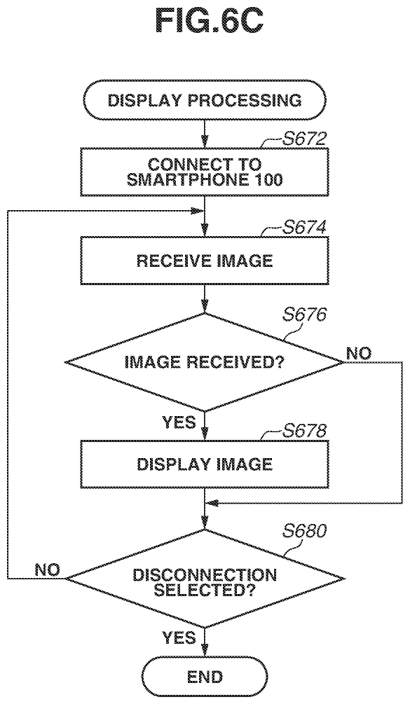

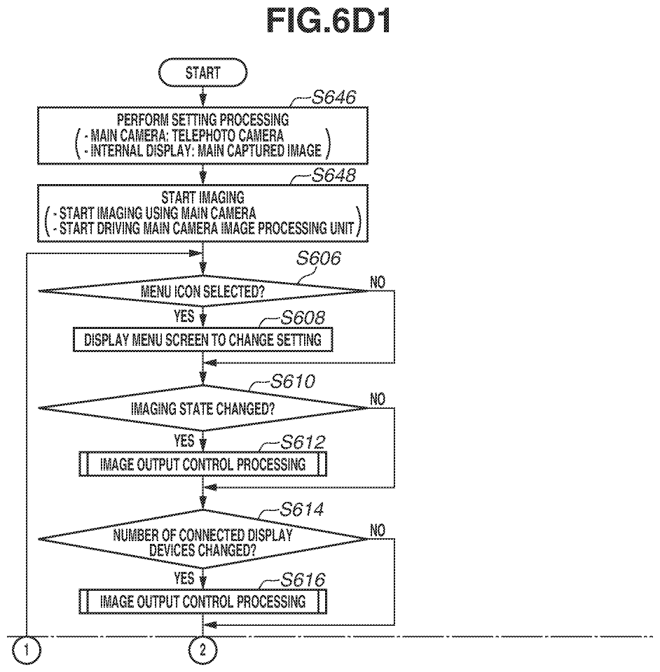

FIGS. 6A1 and 6A2 are a flowchart illustrating processing performed by the smartphone 100. The processing in the flowchart in FIGS. 6A1 and 6A2 is implemented by the CPU 101 executing a program stored in the nonvolatile memory 103. The processing in the flowchart in FIGS. 6A1 and 6A2 is started while the smartphone 100 is in the imaging standby state after startup of a camera application, and is continuously performed.

Alternatively, the processing can be started while the smartphone 100 is in the imaging standby state in the case of activating a display function of an application for performing smartphone connection processing without being limited to the case where the camera application is started up. The processing can be started while the smartphone 100 is in an imaging state instead of the imaging standby state.

In step S602, the CPU 101 performs a camera device setting and a display setting. The CPU 101 performs the camera device setting and the display setting based on set values for imaging display settings (described below) stored in a nonvolatile memory 103. In the present exemplary embodiment, the CPU 101 sets the standard camera 114b as the main camera and the telephoto camera 114a as the sub camera. The CPU 101 also sets an image captured by the main camera (hereinafter also referred to as a main captured image) as an image to be displayed on an internal display and an image captured by the sub camera (hereinafter also referred to as a sub captured image) as an image to be displayed on an external display. The internal display corresponds to the display 105 of the smartphone 100, and the external display corresponds to the display 205 of the smartphone 200. The captured images correspond to live view images (LV images).

In step S604, the CPU 101 starts imaging based on the settings in step S602. In the present exemplary embodiment, the CPU 101 starts imaging using the standard camera 114b and starts driving the standard camera image processing unit 104b. The CPU 101 also starts imaging using the telephoto camera 114a and starts driving the telephoto camera image processing unit 104a.

In step S606, the CPU 101 determines whether a menu icon is selected by the “touch-down” and the “touch-up” on the touch panel 106a. In a case where the menu icon is selected (YES in step S606), the processing proceeds to step S608. In a case where the menu icon is not selected (NO in step S606), the processing proceeds to step S610.

In step S608, the CPU 101 displays a menu screen and changes the set values for the imaging display settings related to imaging and display, in response to a user operation performed on the touch panel 106a. The CPU 101 stores the changed set values for the imaging display settings in the nonvolatile memory 103. In the present exemplary embodiment, examples of setting screens for two functions of the camera device setting and the display setting will be described.

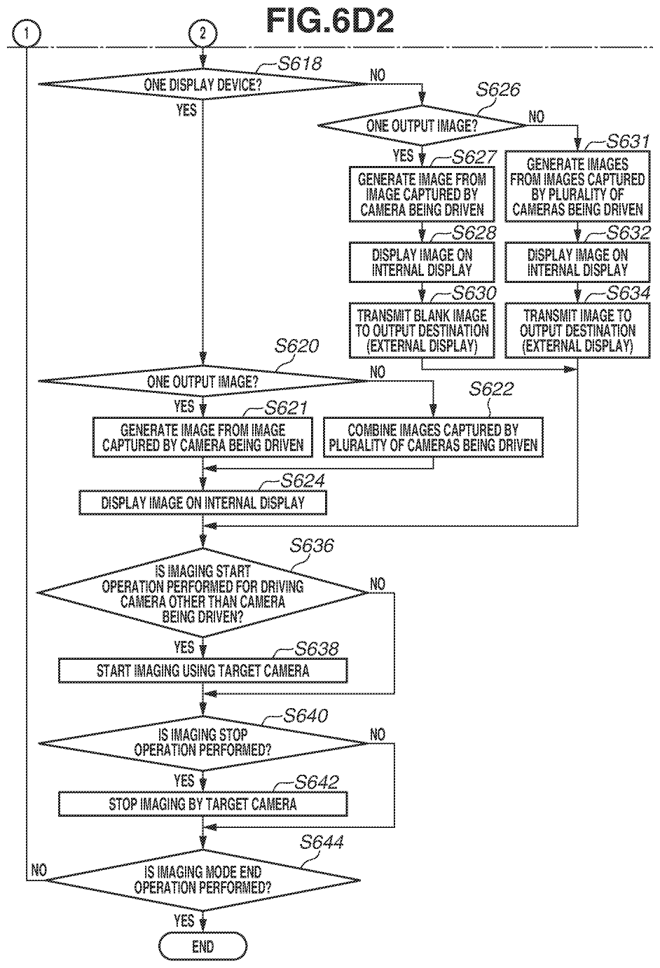

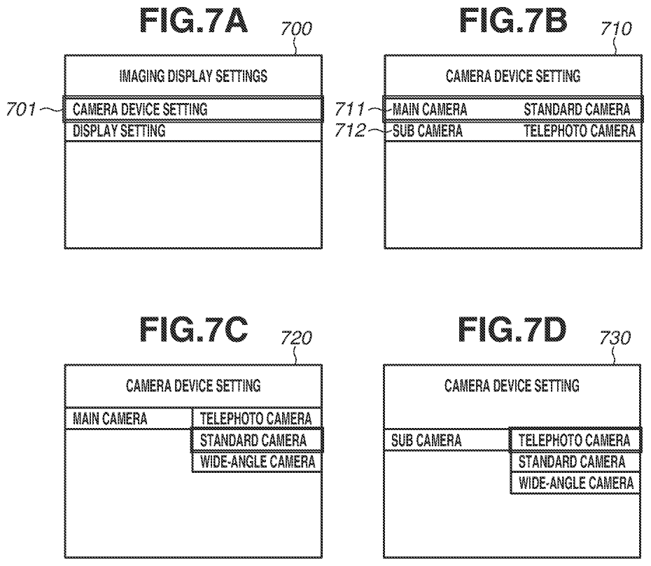

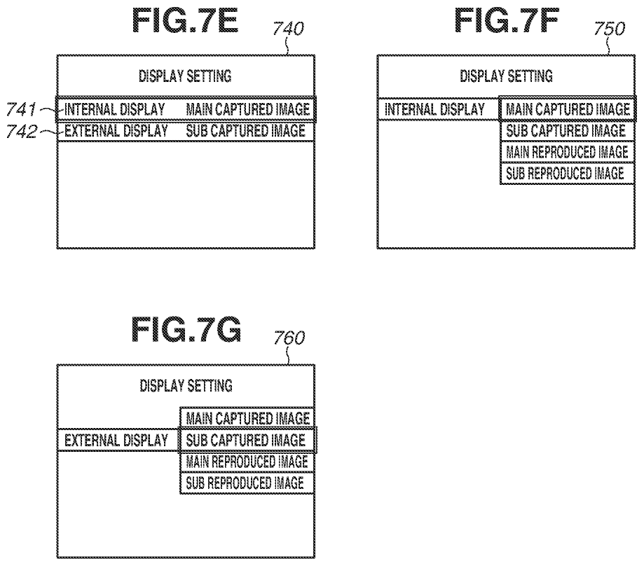

FIG. 7A illustrates an example of a menu screen 700.

A list of functions that can be set is displayed on the menu screen 700. The user moves a cursor 701 by using a member included in the operation unit 106 or performing a touch operation, and selects a desired function to shift to a setting change screen for the selected function.

FIG. 7B illustrates an example of a camera device setting screen 710. When the user selects the camera device setting on the menu screen 700, the menu screen 700 transitions to the camera device setting screen 710. A main camera setting item 711 and a sub camera setting item 712 are displayed on the camera device setting screen 710. The currently set value is displayed for each of the main camera setting item 711 and the sub camera setting item 712. The main camera setting item 711 is used to set the camera to be used as the main camera. The sub camera setting item 712 is used to set the camera to be used as the sub camera.

FIG. 7C illustrates an example of a main camera setting screen 720. When the user selects the main camera setting item 711 on the camera device setting screen 710, the camera device setting screen 710 transitions to the main camera setting screen 720. A plurality of values that can be set for the main camera is displayed on the main camera setting screen 720. The user can select a value other than the default value “standard camera”, such as “telephoto camera” or “wide-angle camera”. The value selected by the user on the main camera setting screen 720 is stored as the main camera.

FIG. 7D illustrates an example of a sub camera setting screen 730. When the user selects the sub camera setting item 712 on the camera device setting screen 710, the camera device setting screen 710 transitions to the sub camera setting screen 730. A plurality of values that can be set for the sub camera is displayed on the sub camera setting screen 730. The user can select a value other than the default value “telephoto camera”, such as “standard camera” or “wide-angle camera”. The main camera setting and the sub camera setting are in an exclusive relationship, and thus, the same value is not selectable for both of the settings. The value selected by the user on the sub camera setting screen 730 is stored as the sub camera.

FIG. 7E illustrates an example of a display setting screen 740. When the user selects the display setting on the menu screen 700, the menu screen 700 transitions to the display setting screen 740. An internal display setting item 741 and an external display setting item 742 are displayed on the display setting screen 740. The currently set value is displayed for each of the internal display setting item 741 and the external display setting item 742. The internal display setting item 741 is used to set the type of image to be displayed on the display 105 serving as the internal display. The external display setting item 742 is used to set the type of image to be displayed on the display 205 serving as the external display.

FIG. 7F illustrates an example of an internal display setting screen 750. When the user selects the internal display setting item 741 on the display setting screen 740, the display setting screen 740 transitions to the internal display setting screen 750. Values for the images that can be displayed on the internal display are displayed on the internal display setting screen 750. The user can select whether to display the image captured by the main camera or the sub camera or to display the image captured and recorded by the main camera or the sub camera. More specifically, the user can select a value other than the default value “main captured image”, which is the image captured by the main camera, such as “sub captured image”, which is the image captured by the sub camera, “main reproduced image”, which is a reproduced image of the image captured by the main camera, or “sub reproduced image”, which is a reproduced image of the image captured by the sub camera. The value selected by the user on the internal display setting screen 750 is stored as the image to be displayed on the internal display. Each of the reproduced images corresponds to an image obtained by reproducing a recorded image.

FIG. 7G illustrates an example of an external display setting screen 760. When the user selects the external display setting item 742 on the display setting screen 740, the display setting screen 740 transitions to the external display setting screen 760. Values for the images that can be displayed on the external display are displayed on the external display setting screen 760. The user can select whether to display the image captured by the main camera or the sub camera or to display the image captured and recorded by the main camera or the sub camera. More specifically, the user can select a value other than the default value “sub captured image”, such as “main captured image”, “main reproduced image”, or “sub reproduced image”. The internal display setting and the external display setting are in an exclusive relationship, and thus, the same value is not selectable for both of the settings. The value selected by the user on the external display setting screen 760 is stored as the image to be displayed on the external display.

Returning to the flowchart in FIGS. 6A1 and 6A2, the description of the processing will be continued.

In step S610, the CPU 101 determines whether the imaging state is changed. More specifically, the CPU 101 determines whether the number of the rear cameras 114 being driven is changed. In a case where the number of the rear cameras 114 being driven is increased or decreased (YES in step S610), the processing proceeds to step S612. In a case where the number of the rear cameras 114 being driven is not changed (NO in step S610), the processing proceeds to step S614.

In step S612, the CPU 101 performs image output control processing.

FIG. 6B is a flowchart illustrating the image output control processing in step S612.

In step S652, the CPU 101 acquires, from the display device management unit 121, information about the number of display devices connected to the smartphone 100, and determines whether the number of connected display devices is one. In a case where the number of connected display devices is one (YES in step S652), the processing proceeds to step S654. In a case where the number of connected display devices is greater than one (NO in step S652), the processing proceeds to step S660.

In step S654, the CPU 101 counts the number of cameras being driven and determines whether the number of cameras being driven is one. In a case where the number of cameras being driven is one (YES in step S654), the processing proceeds to step S656. In a case where the number of cameras being driven is greater than (NO in step S654), the processing proceeds to step S658.

In step S656, the CPU 101 sets an output destination and an output image in the display device management unit 121 based on the set values for the imaging display settings. More specifically, the CPU 101 sets the smartphone 100 as the output destination and the LV image captured by the main camera (hereinafter referred to as the main camera LV image) as the output image.

In step S658, the CPU 101 sets the output destination and the output images in the display device management unit 121 based on the set values for the imaging display settings. More specifically, the CPU 101 sets the smartphone 100 as the output destination, and the main camera LV image and the LV image captured by the sub camera (hereinafter referred to as the sub camera LV image) as the output images. In a case where the number of connected display devices is one and the number of cameras being driven is, for example, two, the images captured by the two cameras are output to the one display device.

In step S660, the CPU 101 counts the number of cameras being driven and determines whether the number of cameras being driven is one. In a case where the number of cameras being driven is one (YES in step S660), the processing proceeds to step S662. In a case where the number of cameras being driven is greater than one, (NO in step S660), the processing proceeds to step S666.

In step S662, the CPU 101 sets the output destination and the output image in the display device management unit 121 based on the set values for the imaging display settings. More specifically, the CPU 101 sets the smartphone 100 as the output destination and the main camera LV image as the output image. The processing then proceeds to step S664.

In step S664, the CPU 101 sets the output destination and the output image in the display device management unit 121 based on the set values for the imaging display settings. More specifically, the CPU 101 sets the smartphone 200 as the output destination and a blank image as the output image. In the imaging display settings according to the present exemplary embodiment, the value for the sub captured image is set for the external display, but the sub camera is not driven. Accordingly, a blank image is output to the smartphone 200 serving as the external display.

In step S666, the CPU 101 sets the output destination and the output image in the display device management unit 121 based on the set values for the imaging display settings. More specifically, the CPU 101 sets the smartphone 100 as the output destination and the main camera LV image as the output image. The processing then proceeds to step S668.

In step S668, the CPU 101 sets the output destination and the output image in the display device management unit 121 based on the set values for the imaging display settings. More specifically, the CPU 101 sets the smartphone 200 as the output destination and the sub camera LV image as the output image.

Returning to the flowchart in FIGS. 6A1 and 6A2, the description of the processing will be continued.

In step S614, the CPU 101 determines whether the number of connected display devices is changed, based on information about the number of devices managed by the display device management unit 121. In a case where the number of connected display devices is changed (YES in step S614), the processing proceeds to step S616. In a case where the number of connected display devices is not changed (NO in step S614), the processing proceeds to step S618.

In step S616, the CPU 101 performs the image output control processing. This processing is similar to that in step S612 and a detailed description is omitted herein.

In step S618, the CPU 101 determines whether the number of connected display devices is one based on the information about the number of devices managed by the display device management unit 121. In a case where the number of connected display devices is one (YES in step S618), the processing proceeds to step S620. In a case where the number of connected display devices is greater than one (NO in step S618), the processing proceeds to step S626. More specifically, in a case where the smartphone 200 is not connected to the smartphone 100, one display device, i.e., the display 105 on the smartphone 100 is determined to be connected to the smartphone 100. In a case where the smartphone 200 is connected to the smartphone 100, two display devices, i.e., the display 105 on the smartphone 100 and the display 205 on the smartphone 200 are determined to be connected to the smartphone 100.

In step S620, the CPU 101 determines the number of output images set in the display device management unit 121. In a case where the number of set output images is one (YES in step S620), the processing proceeds to step S621. In a case where the number of set output images is greater than one, (NO in step S620), the processing proceeds to step S622. For example, in a case where the number of output destinations is one and the number of output images is one, i.e., the output destination is the smartphone 100 and the output image is the main camera LV image, the processing proceeds to step S621. In a case where the number of output destinations is one and the number of output images is two, i.e., the output destination is the smartphone 100 and the output images are the main camera LV image and the sub camera LV image, the processing proceeds to step S622.

In step S621, the CPU 101 generates one image using the corresponding rear camera image processing unit 104 based on the output image set in the display device management unit 121. For example, in a case where the output destination is the smartphone 100 and the main camera LV image is set as the output image, the CPU 101 generates an image based on the main camera LV image. The CPU 101 can generate an image by editing the main camera LV image or simply using the main camera LV image. The processing then proceeds to step S624.

In step S622, the CPU 101 generates one combined image by combining two output images using the corresponding rear camera image processing units 104 based on the output images set in the display device management unit 121. For example, in a case where the output destination is the smartphone 100 and the main camera LV image and the sub camera LV image are set as the output images, the CPU 101 combines the main camera LV image and the sub camera LV image to generate one combined image. The processing then proceeds to step S624.

In step S624, the CPU 101 displays the image generated using the corresponding rear camera image processing unit(s) 104.

Since one display device, i.e., the display 105 on the smartphone 100 is determined to be connected to the smartphone 100, the CPU 101 displays the generated image on the display 105 and no image is displayed on the display 205.

FIG. 5A illustrates an example of a mode where an image captured by one camera is displayed on one display in a case where one display device is connected to the smartphone 100. In the example of FIG. 5A, the image is displayed on the display 105 of the smartphone 100, whereas no image is displayed on the display 205 of the smartphone 200, which is not connected to the smartphone 100.

FIG. 5B illustrates an example of a mode where images respectively captured by two cameras are displayed on one display in a case where one display device is connected to the smartphone 100. In the example of FIG. 5B, a combined image obtained by combining two types of images in a picture-in-picture format is displayed on the display 105 of the smartphone 100. In the example of FIG. 5B, the combined image in which the sub camera LV image is small with respect to the main camera LV image is displayed. By changing the set values for the imaging display settings, it is possible to display a combined image in which a captured image with a narrower range is small with respect to a captured image with a wider range.

Returning to the flowchart in FIGS. 6A1 and 6A2, the description of the processing will be continued.

In step S626, the CPU 101 determines the number of output images set in the display device management unit 121. In a case where the number of set output images is one (YES in step S626), the processing proceeds to step S627. In a case where the number of set output images is greater than one (NO in step S626), the processing proceeds to step S631. For example, in a case where the output destinations are the smartphone 100 and the smartphone 200, and the number of set output image is one, i.e., the output image is the main camera LV image, the processing proceeds to step S627. In a case where the output destinations are the smartphone 100 and the smartphone 200 and the number of set output image is two, i.e., the output images are the main camera LV image and the sub camera LV image, the processing proceeds to step S631.

In step S627, the CPU 101 generates one image using the corresponding rear camera image processing unit 104 based on the output image set in the display device management unit 121. For example, in a case where the output destinations are two smartphones, i.e., the smartphone 100 and the smartphone 200 and the main camera LV image is set as the output image, the CPU 101 generates an image based on the main camera LV image. The CPU 101 can generate an image by editing the main camera LV image or simply using the main camera LV image. The processing then proceeds to step S628.

In step S628, the CPU 101 displays the generated image on the first output destination. More specifically, the CPU 101 displays the image generated based on the main camera LV image, on the display 105 of the smartphone 100 set as the first output destination. The processing then proceeds to step S630.

In step S630, the CPU 101 transmits a blank image to the second output destination via the external I/F 109 so that the blank image is displayed thereon. More specifically, the CPU 101 transmits the blank image to the smartphone 200 in order to display the blank image on the display 205 of the smartphone 200 set as the second output destination. Accordingly, the blank image is displayed on the display 205 of the smartphone 200.

FIG. 5D illustrates an example of a mode where, if two display devices are connected to the smartphone 100, an image captured by one camera is displayed on the first display and a blank image is displayed on the second display. In the example of FIG. 5D, the LV image captured by the standard camera 114b is displayed as the main camera LV image on the display 105 of the smartphone 100, whereas the blank image is displayed on the display 205 of the smartphone 200.

Returning to the flowchart in FIGS. 6A1 and 6A2, the description of the processing will be continued.

In step S631, the CPU 101 generates two images using the corresponding rear camera image processing units 104 based on the output images sets in the display device management unit 121. For example, in a case where the output destinations are two smartphones, i.e., the smartphone 100 and the smartphone 200, and the main camera LV image and the sub camera LV image are set as the output images, the CPU 101 generates an image based on the main camera LV image and an image based on the sub camera LV image. The CPU 101 can generate the images by respectively editing the main camera LV image and the sub camera LV image or simply using the main camera LV image and the sub camera LV image. The processing then proceeds to step S632.

In step S632, the CPU 101 displays the generated image corresponding to the output image set in the display device management unit 121 on the first output destination. More specifically, the CPU 101 displays the image generated based on the main camera LV image, on the display 105 of the smartphone 100 set as the first output destination. The processing then proceeds to step S634.

In step S634, the CPU 101 transmits the generated image corresponding to the output image set in the display device management unit 121 to the second output destination via the external I/F 109 so that the image is displayed thereon. More specifically, the CPU 101 transmits the image generated based on the sub camera LV image to the smartphone 200 in order to display the image generated based on the sub camera LV image on the display 205 of the smartphone 200 set as the second output destination. Accordingly, the image generated based on the sub camera LV image is displayed on the display 205 of the smartphone 200.

FIG. 5C illustrates an example of a mode where, if two display devices are connected to the smartphone 100, an image captured by the first camera is displayed on the first display and an image captured by the second camera is displayed on the second display. In the example of FIG. 5C, the main camera LV image is displayed on the display 105 of the smartphone 100, whereas the sub camera LV image is displayed on the display 205 of the smartphone 200.

Display processing performed by the smartphone 200, which is the output destination, will now be described.

FIG. 6C is a flowchart illustrating processing performed by the smartphone 200. The processing in the flowchart in FIG. 6C is implemented by the CPU 201 executing a program stored in the nonvolatile memory 203.

In step S672, the CPU 201 is connected to the smartphone 100 via the external OF 209. At this time, the number of devices managed by the display device management unit 121 of the smartphone 100 is increased from one to two.

In step S674, the CPU 201 receives the image transmitted from the smartphone 100 via the external OF 209 and stores the image in a memory 202.

In step S676, the CPU 201 determines whether the image is received. In a case where the image is received (YES in step S676), the processing proceeds to step S678. In a case where the image is not received (NO in step S676), the processing proceeds to step S680.

In step S678, the CPU 201 displays the image stored in the memory 202 on the display 205. At this time, the sub camera LV image is displayed on the display 205 as illustrated in FIG. 5C, or the blank image is displayed on the display 205 as illustrated in FIG. 5D.

In step S680, the CPU 201 determines whether disconnection of the smartphone 200 from the smartphone 100 is selected by the “touch-down” and “touch-up” of a disconnection icon on a touch panel 206a. In a case where the disconnection is selected (YES in step S680), the processing is terminated. In a case where the disconnection is not selected (NO in step S680), the processing returns to step S674.

Returning to the flowchart in FIGS. 6A1 and 6A2, the description of the processing by the smartphone 100 will be continued.

In step S636, the CPU 101 determines whether the user performs an imaging start operation by performing a touch operation on the touch panel 106a in order to drive a camera other than the camera(s) being driven from among the rear cameras 114. In a case where the operation is performed (YES in step S636), the processing proceeds to step S638. In a case where the operation is not performed (NO in step S636), the processing proceeds to step S640.

In step S638, the CPU 101 starts imaging using the camera for which the imaging start operation is performed.

The CPU 101 also starts driving the rear camera image processing unit 104 corresponding to the camera for which the imaging start operation is performed. The processing then proceeds to step S640.

In step S640, the CPU 101 determines whether the user performs an imaging stop operation by performing a touch operation on the touch panel 106a in order to stop driving a camera being driven among the rear cameras 114. In a case where the operation is performed (YES in step S640), the processing proceeds to step S642. In a case where the operation is not performed (NO in step S640), the processing proceeds to step S644.

In step S642, the CPU 101 stops imaging by the camera for which the imaging stop operation is performed. The CPU 101 also stops driving the rear camera image processing unit 104 corresponding to the camera for which the imaging stop operation is performed.

In step S644, the CPU 101 determines whether the user performs an imaging mode end operation by performing a touch operation on the touch panel 106a. In a case where the operation is performed (YES in step S644), the processing in the flowchart in FIGS. 6A1 and 6A2 is terminated. In a case where the operation is not performed (NO in step S644), the processing returns to step S606 and continues.

As described above, according to the present exemplary embodiment, the CPU 101 controls the images captured by a plurality of cameras to be displayed in a different mode depending on the number of display devices connected to the smartphone 100. For example, as illustrated in FIG. 5B, in a case where the number of connected display devices is one, the images respectively captured by two cameras are displayed on one display device. As illustrated in FIG. 5C, in a case where the number of connected display devices is two, the images respectively captured by two cameras are displayed on different display devices, i.e., displayed separately on the two display devices. Therefore, the images captured by the plurality of cameras can be easily viewed. Since the images can be easily viewed in this manner, visibility is improved, and the user can improve work efficiency and viewing accuracy.

According to the present exemplary embodiment, the CPU 101 controls the images captured by a plurality of cameras to be changed and displayed in a different mode depending on the increase or decrease in the number of display devices connected to the smartphone 100. For example, in a case where the number of connected display devices increases from one to two, the above-described processing proceeds from step S614 to step S616, and the display devices connected to the smartphone 100 are set in the image output control processing in the flowchart in FIG. 6B. The processing then proceeds from step S618 to step S626 to enable automatically changing the images and respectively displaying them on the two connected display devices. This provides for improved user operability in viewing images captured by a plurality of cameras after connection of the display devices.

According to the present exemplary embodiment, the CPU 101 controls an image to be displayed on a display device to be changed and displayed in a different mode depending on the increase or decrease in the number of cameras being driven among the plurality of cameras. For example, in a case where the number of cameras being driven increases from one to two or decreases from two to one, the above-described processing proceeds from step S610 to step S612, and the output image setting is changed in the image output control processing in the flowchart in FIG. 6B. Accordingly, the processing proceeds from step S620 to step S621 or S622, or proceeds from step S626 to step S627 or S631, which enables automatically changing the image to be displayed and displaying the image even on the same display device. This provides an improvement to user operability in viewing camera-captured images.

According to the present exemplary embodiment, in a case where the number of connected display devices is two or more and greater than or equal to the number of cameras being driven, the CPU 101 can control the images respectively captured by the plurality of cameras to be displayed on different display devices. For example, in a case where the number of connected display devices is three and the number of cameras being driven is two, the CPU 101 controls the images respectively captured by the two cameras to be displayed on different display devices. More specifically, the CPU 101 displays the first image on the first display device and the second image on the second display device. The CPU 101 can display a blank image, either the first image or the second image, or a combined image of the first image and the second image on the third display device.

The present exemplary embodiment describes a case where an image to be displayed is a captured image. In another exemplary embodiment, the image to be displayed can be a reproduced image. The present exemplary embodiment also describes a case where the number of cameras to be driven is two. In another exemplary embodiment, the number of cameras to be driven can be any number of cameras greater than two. The present exemplary embodiment describes a case where the number of display devices to be connected is two. In another exemplary embodiment, the number of display devices to be connected can be any number greater than two.

In a second exemplary embodiment, the telephoto camera 114a is driven as the main camera, and the smartphone 100 and the smartphone 200 are connected to each other to set two display devices, i.e., the display 105 and the display 205. The standard camera 114b is then driven as the sub camera. Processing for changing the display states of the display 105 and the display 205 in a case where the telephoto camera 114a is driven first and then the state is changed to a state where the telephoto camera 114a and the standard camera 114b are driven at the same time as described above will now be described.

FIGS. 5E and 5F each illustrate a state in which the smartphone 100 is connected to the smartphone 200.

FIGS. 6D1 and 6D2 are a flowchart illustrating processing performed by the smartphone 100. The description of processing similar to that in FIGS. 6A1 and 6A2 will be included as needed.

In step S646, the CPU 101 performs the camera device setting and the display setting. In the present exemplary embodiment, the CPU 101 sets the telephoto camera 114a as the main camera. The CPU 101 also sets the main captured image as the image to be displayed on the internal display.

In step S648, the CPU 101 starts imaging based on the settings in step S646. In the present exemplary embodiment, the CPU 101 starts imaging using the telephoto camera 114a and starts driving the telephoto camera image processing unit 104a.

In step S610, the CPU 101 determines whether the imaging state is changed. More specifically, the CPU 101 determines whether the number of the rear cameras 114 being driven is changed. In the present exemplary embodiment, the driving of the standard camera 114b as the sub camera is started and the number of the rear cameras 114 being driven is changed (YES in step S610) and thus the processing proceeds to step S612.

The image output control processing in step S612 is similar to that in the flowchart in FIG. 6B described in the first exemplary embodiment and as such a detailed description is omitted herein.

In step S614, the CPU 101 determines, based on the information about the number of devices managed by the display device management unit 121, whether the number of connected display devices is changed. In the present exemplary embodiment, the number of display devices is not changed (NO in step S614), and thus the processing proceeds to step S618.

In step S618, the CPU 101 determines, based on the information about the number of devices managed by the display device management unit 121, whether the number of connected display devices is one. In the present exemplary embodiment, two display devices, i.e., the display 105 and the display 205 are connected to the smartphone 100 (NO in step S618), and thus the processing proceeds to step S626.

In step S626, the CPU 101 determines the number of output images set in the display device management unit 121. In the present exemplary embodiment, while the telephoto camera 114a is driven as the main camera, one image, i.e., the main camera LV image is set as the output image (YES in step S626), and thus the processing proceeds to step S627. When the driving of the standard camera 114b as the sub camera is started and the state is changed to the state where the telephoto camera 114a and the standard camera 114b are driven at the same time, two images, i.e., the main camera LV image and the sub camera LV image are set as the output images (NO in step S626), and the processing proceeds to step S631.

In step S627, the CPU 101 generates one image using the corresponding rear camera image processing unit 104 based on the output image set in the display device management unit 121. The processing then proceeds to step S628.

In step S628, the CPU 101 displays the generated image on the first output destination. More specifically, the CPU 101 displays the image generated based on the main camera LV image on the display 105 of the smartphone 100 set as the first output destination. The processing then proceeds to step S630.

In step S630, the CPU 101 transmits a blank image to the second output destination via the external I/F 109 in order to display the blank image thereon. More specifically, the CPU 101 transmits the blank image to the smartphone 200 to display the blank image on the display 205 of the smartphone 200 set as the second output destination.

FIG. 5E illustrates an example of a mode where, if two display devices are connected to the smartphone 100, an image captured by one camera is displayed on the first display and a blank image is displayed on the second display. In the example of FIG. 5E, the LV image captured by the telephoto camera 114a is displayed as the main camera LV image on the display 105 of the smartphone 100.

In step S631, the CPU 101 generates two images using the corresponding rear camera image processing units 104 based on the output images sets in the display device management unit 121. The processing then proceeds to step S632.

In step S632, the CPU 101 displays, on the first output destination, the generated image corresponding to the output image set in the display device management unit 121. More specifically, the CPU 101 displays the image generated based on the main camera LV image, on the display 105 of the smartphone 100 set as the first output destination. The processing then proceeds to step S634.

In step S634, the CPU 101 transmits the generated image corresponding to the output image set in the display device management unit 121 to the second output destination via the external I/F 109 in order to display the image thereon. More specifically, the CPU 101 transmits the image generated based on the sub camera LV image to the smartphone 200 in order to display the image generated based on the sub camera LV image on the display 205 of the smartphone 200 set as the second output destination.

The display processing performed by the smartphone 200, which is the output destination, is similar to that in the flowchart in FIG. 6C, and thus a detailed description is omitted herein.

FIG. 5F illustrates an example of a mode where, if two display devices are connected to the smartphone 100, an image captured by the first camera is displayed on the first display and an image captured by the second camera is displayed on the second display. In the example of FIG. 5F, the image captured by the telephoto camera 114a is displayed as the main camera LV image on the display 105 of the smartphone 100.

The image captured by the standard camera 114b is displayed as the sub camera LV image on the display 205 of the smartphone 200.

Returning to the flowchart in FIGS. 6D1 and 6D2, the description of the processing by the smartphone 100 will be continued.

In step S636, the CPU 101 determines whether the user performs the imaging start operation by performing a touch operation on the touch panel 106a in order to drive a camera other than the camera(s) being driven from among the rear cameras 114. In a case where the operation is performed (YES in step S636), the processing proceeds to step S638. In a case where the operation is not performed (NO in step S636), the processing proceeds to step S640. In the present exemplary embodiment, when the driving of the standard camera 114b as the sub camera is started in the middle of the processing, the user performs the imaging start operation (YES in step S636), and the processing proceeds to step S638.

In step S638, the CPU 101 starts imaging using the camera for which the imaging start operation is performed.

The CPU 101 also starts driving the rear camera image processing unit 104 corresponding to the camera for which the imaging start operation is performed. In the present exemplary embodiment, when the imaging start operation is performed in order to start driving the standard camera 114b as the sub camera in the middle of the processing, the driving of the standard camera 114b is started.

As described above, according to the present exemplary embodiment, the CPU 101 controls the images captured by the plurality of cameras to be displayed in a different mode depending on the number of display devices connected to the smartphone 100. Accordingly, the images captured by the plurality of cameras can be easily viewed.

In the present exemplary embodiment, the case is described in which an image to be displayed is a captured image. In another exemplary embodiment, the image to be displayed can be a reproduced image. The present exemplary describes a case where the number of cameras to be driven is two. In another exemplary embodiment, the number of cameras to be driven can be any number greater than two. The present exemplary embodiment describes a case where the number of display devices to be connected is two. In another exemplary embodiment, the number of display devices to be connected can be any number greater than two.

### OTHER EMBODIMENTS

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The above-described exemplary embodiments are described using an example of a case where an electronic apparatus is a smartphone. In other exemplary embodiments, any electronic apparatus that includes a plurality of image capturing units and can manage a display device and control the display is applicable. For example, a personal computer, a personal digital assistant (PDA), a digital camera, a portable image viewer, a printer apparatus equipped with a display, a digital photo frame, a music player, a game machine, an electronic book reader, etc. are applicable.

While the above-described exemplary embodiments have been described, these embodiments are not seen to be limiting, and various forms are applicable without departing from the essence of these embodiments. Parts of the above-described exemplary embodiments can be combined with each other as appropriate.

While the above-described exemplary embodiments have been provided, these embodiments are not seen to be limiting. The scope of the following claims is to be accorded the broadest interpretation so as to encompass all such modifications and equivalent structures and functions.

This application claims the benefit of Japanese Patent Application No. 2022-017379, filed Feb. 7, 2022, which is hereby incorporated by reference herein in its entirety.

What is claimed is:

1. An electronic apparatus comprising:
a plurality of image capturing units;
a first display device;
a connection unit configured to connect an external second display device to the electronic apparatus; and
a control unit configured to control, depending on a number of display devices including the first display device and the external second display device, displaying a plurality of images generated by the plurality of image capturing units on the display devices in a different mode.

2. The electronic apparatus according to claim 1, wherein, in a case where the number of display devices including the first display device and the external second display device is greater than or equal to two and greater than or equal to a number of images generated by the plurality of image capturing units, the control unit is configured to control displaying the plurality of images respectively generated by the plurality of image capturing units on different display devices including the first display device and the external second display device.

3. The electronic apparatus according to claim 1, wherein, in a case where the number of display devices including the first display device and the external second display device is one, the control unit is configured to control combining the plurality of images generated by the plurality of image capturing units to obtain a combined image and to control displaying the combined image on one display device.

4. The electronic apparatus according to claim 1, wherein, in a case where the number of display devices including the first display device and the external second display device is greater than a number of images generated by the plurality of image capturing units, the control unit is configured to control displaying a blank image on at least one of the display devices.

5. The electronic apparatus according to claim 1,
wherein the plurality of image capturing units includes a first image capturing unit and a second image capturing unit,
wherein, in a case where the number of display devices including the first display device and the external second display device is one, the control unit is configured to control combining a first image generated by the first image capturing unit and a second image generated by the second image capturing unit to obtain a third image and to control displaying the third image on one display device, and
wherein, in a case where the number of display devices including the first display device and the external second display device increases from one to two, the control unit is configured to control displaying the first image on one display device and the second image on another display device.

6. The electronic apparatus according to claim 1, wherein the control unit is configured to control changing images and displaying images in a different mode on the display devices depending on a change in a number of image capturing units being driven from among the plurality of image capturing units.

7. The electronic apparatus according to claim 1,
wherein the plurality of image capturing units includes a first image capturing unit and a second image capturing unit,
wherein, in a case where the number of display devices including the first display device and the external second display device is two and both of the first image capturing unit and the second image capturing unit are driven, the control unit is configured to control displaying a first image generated by the first image capturing unit on one display device and an image generated by the second image capturing unit on another display device, and
wherein, in a case where the number of display devices including the first display device and the external second display device is two and the first image capturing unit is driven and the second image capturing unit is not driven, the control unit is configured to control displaying the first image on the first display device and displaying a blank image on the external second display device.

8. The electronic apparatus according to claim 1, wherein the plurality of images are live view images.

9. The electronic apparatus according to claim 1, wherein the control unit is configured to control recording the plurality of images captured by the plurality of image capturing units in a recording medium,
wherein images displayed on the display devices are the plurality of images recorded in the recording medium.

10. The electronic apparatus according to claim 1, wherein the plurality of image capturing units simultaneously images a subject to generate the plurality of images.

11. The electronic apparatus according to claim 1, wherein the plurality of image capturing units respectively images a subject via lenses having different focal lengths to generate the plurality of images.

12. A method for controlling an electronic apparatus including a plurality of image capturing units, a first display device, and a connection unit configured to connect an external second display device to the electronic apparatus, the method comprising:
detecting connection of the external second display device;
imaging a subject using the plurality of image capturing units to generate a plurality of images; and
controlling, depending on a number of display devices including the first display device and the external second display device, displaying the plurality of images on the display devices in a different mode.

13. The method according to claim 12, wherein, in a case where the number of display devices including the first display device and the external second display device is greater than or equal to two and greater than or equal to a number of images generated by the plurality of image capturing units, control is performed to display the plurality of images respectively generated by the plurality of image capturing units on different display devices including the first display device and the external second display device.

14. The method according to claim 12, wherein, in a case where the number of display devices including the first display device and the external second display device is one, control is performed to combine the plurality of images generated by the plurality of image capturing units to obtain a combined image and to display the combined image on one display device.

15. The method according to claim 12, wherein, in a case where the number of display devices including the first display device and the external second display device is greater than a number of images generated by the plurality of image capturing units, control is performed to display a blank image on at least one of the display devices.

16. The method according to claim 12,
wherein the plurality of image capturing units includes a first image capturing unit and a second image capturing unit,
wherein, in a case where the number of display devices including the first display device and the external second display device is one, control is performed to combine a first image generated by the first image capturing unit and a second image generated by the second image capturing unit to obtain a third image and to display the third image on one display device, and
wherein, in a case where the number of display devices including the first display device and the external second display device increases from one to two, control is performed to display the first image on one display device and the second image on another display device.

17. The method according to claim 12, wherein control is performed to change images and to display images in a different mode on the display devices depending on a change in a number of image capturing units being driven from among the plurality of image capturing units.

18. The method according to claim 12,
wherein the plurality of image capturing units includes a first image capturing unit and a second image capturing unit,
wherein, in a case where the number of display devices including the first display device and the external second display device is two and both of the first image capturing unit and the second image capturing unit are driven, control is performed to display a first image generated by the first image capturing unit on one display device and an image generated by the second image capturing unit on another display device, and
wherein, in a case where the number of display devices including the first display device and the external second display device is two and the first image capturing unit is driven and the second image capturing unit is not driven, control is performed to display the first image on the first display device and display a blank image on the external second display device.

19. The method according to claim 12, wherein the plurality of images is live view images.

20. The method according to claim 12, wherein control is performed to record the plurality of images captured by the plurality of image capturing units in a recording medium,
wherein images displayed on the display devices are the plurality of images recorded in the recording medium.

21. The method according to claim 12, wherein the plurality of image capturing units simultaneously images the subject to generate the plurality of images.

22. The method according to claim 12, wherein the plurality of image capturing units respectively images the subject via lenses having different focal lengths to generate the plurality of images.

23. A non-transitory computer-readable storage medium storing a program for causing an electronic apparatus including a plurality of image capturing units, a first display device, and a connection unit configured to connect an external second display device to the electronic apparatus to execute a method, the method comprising:
detecting connection of the external second display device;
imaging a subject using the plurality of image capturing units to generate a plurality of images; and
controlling, depending on a number of display devices including the first display device and the external second display device, displaying the plurality of images on the display devices in a different mode.
